(19) United States
(12) Patent Application Publication
(10) Pub. No.: US 2015/0228088 A1
(43) Pub. Date: Aug. 13, 2015

(54) DISPLAY DEVICE AND METHOD FOR IMAGE UPDATE OF THE SAME

(71) Applicant: SAMSUNG ELECTRONICS CO., LTD., SUWON-SI (KR)

(72) Inventors: SUNG-CHUL YOON, HWASEONG-SI (KR); JONG-HO ROH, YONGIN-SI (KR); JONG-HYUP LEE, SEOUL (KR)

(21) Appl. No.: 14/495,720

(22) Filed: Sep. 24, 2014

(30) Foreign Application Priority Data
Feb. 12, 2014 (KR) 10-2014-0016104

(51) Int. Cl. G06T 9/00; G06T 5/50

(52) U.S. Cl. CPC G06T 9/00; G06T 5/50; G06T 2207/20221

(57) ABSTRACT

Provided are a display device and a method for updating an image of the same. The display device includes a display unit, a processing unit for compressing both image data corresponding to an updated region of the display unit and image data corresponding to a peripheral region adjacent to the updated region together and generating compressed image data, and a display driving unit for receiving the compressed image data and decompressing the image data, wherein the display unit displays an image corresponding to the updated region by the decompressed image data.

### CROSS-REFERENCE TO RELATED APPLICATION

This application claims priority from Korean Patent Application No. 10-2014-0016104 filed on Feb. 12, 2014 in the Korean Intellectual Property Office, and all the benefits accruing therefrom under 35 U.S.C. 119, the contents of which in its entirety are herein incorporated by reference.

### BACKGROUND

1. Field of the Inventive concept

The present inventive concept relates to a display device and an image update method of the same.

2. Description of the Related Art

As the resolution of a display device increases, the size of multimedia data or image data to be displayed on the display device drastically increases. Accordingly, input/output overhead for processing the data is also increasing and power consumption by input/output operations is tremendously increasing. The increase in the power consumption, particularly in a mobile device, greatly affects the performance of a mobile device. Therefore, it is necessary to efficiently process high-capacity multimedia data or image data and to prevent unnecessary data from being input/output.

### SUMMARY

The present inventive concept provides a display device employing a system capable of reducing power consumption even in a high-resolution display by partially updating an image of the display device using image data transmission with compression.

The present inventive concept also provides an image update method of a display device, which can reduce power consumption of the display device by partially updating an image of the display device.

These and other objects of the present inventive concept will be described in or be apparent from the following description of the exemplary embodiments.

According to an aspect of the present inventive concept, there is provided a display device including a display unit, a processing unit compressing both of image data corresponding to an updated region of the display unit and image data corresponding to a peripheral region adjacent to the updated region together and generating compressed image data, and a display driving unit receiving the compressed image data and decompressing the image data, wherein the display unit displays an image corresponding to the updated region by the decompressed image data.

According to another aspect of the present inventive concept, there is provided a display device including a display unit, a processing unit compressing first image data of a first updated region defined to be horizontally and vertically spaced apart from a first position in a frame of the display unit by a particular pixel size and generating first compressed image data, and a display driving unit receiving the first compressed image data and decompressing the first image data, wherein the display unit displays an image corresponding to the first updated region by the decompressed first image data.

### BRIEF DESCRIPTION OF THE DRAWINGS

The above and other features of the present inventive concept will become more apparent by describing in detail exemplary embodiments thereof with reference to the attached drawings in which:

FIG. 1 is a schematic block diagram that illustrates a display device according to a first embodiment of the present inventive concept;

FIG. 2 is a block diagram that illustrates specific modules of a processing unit;

FIG. 3 is a block diagram that illustrates specific modules of a display driving unit;

FIG. 4 schematically illustrates an updated region and a peripheral region;

FIGS. 5 and 6 illustrate a method of compressing both of image data corresponding to an updated region and image data corresponding to a peripheral region;

FIG. 7 is a schematic block diagram of a display device according to a second embodiment of the present inventive concept;

FIG. 8 is a schematic block diagram of a display device according to a third embodiment of the present inventive concept;

FIG. 9 is a schematic block diagram of a display device according to a fourth embodiment of the present inventive concept;

FIG. 10 is a diagram that illustrates a display device according to a fifth embodiment of the present inventive concept;

FIG. 11 is a diagram that illustrates a display device according to a sixth embodiment of the present inventive concept;

FIG. 12 is a flowchart that sequentially illustrates an image update method of a display device according to an embodiment of the present inventive concept;

FIG. 13 is a schematic block diagram of an electronic system including display devices according to various embodiments of the present inventive concept; and

FIG. 14 is a schematic block diagram of an application example of an electronic system including display devices according to various embodiments of the present inventive concept.

### DETAILED DESCRIPTION OF EXEMPLARY EMBODIMENTS

Embodiments of the present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art. The same reference numbers may indicate the same components throughout the specification. In the attached figures, the thickness of layers and regions may be exaggerated for clarity.

It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The use of the terms “a” and “an” and “the” and similar referents in the context of describing the invention, especially in the context of the following claims, are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate the invention and is not a limitation on the scope of the invention unless otherwise specified. Further, unless defined otherwise, all terms defined in generally used dictionaries may not be overly interpreted.

The present invention will be described with reference to perspective views, cross-sectional views, and/or plan views, in which exemplary embodiments of the invention are shown. Thus, the profile of an exemplary view may be modified according to manufacturing techniques and/or allowances. That is, the embodiments of the invention are not intended to limit the scope of the present invention but cover all changes and modifications that can be caused due to a change in manufacturing process. Thus, regions shown in the drawings are illustrated in schematic form and the shapes of the regions are presented simply by way of illustration and not as a limitation.

In a display device and an image updating method of the display device, which will be described below, an image is updated only on a partial region of a frame by using image transmission with compression. That is to say, when a high-speed serial interface, such as a mobile industry processor interface (MIPI), used to transmit image data to a display device, image compression may be necessary according to the resolution of the image. According to the present inventive concept, power consumption can be reduced using a partial update technique.

When a high-resolution display, such as an ultra high density (UHD) (3840×2160), is employed to a terminal using a mobile application processor (AP), due to a limit in the transmission bandwidth, image data is compressed to then be transmitted, the compressed image data should be decompressed using a display device interface.

Recently, to reduce power consumption of a display device, the display device, including a device serving as a display device interface and a frame memory, employs a method in which only image data having an updated image is transmitted to then be partially updated.

However, if compressed image data is transmitted to then be written in a frame memory, in view of compression algorithm characteristics, the compressed image data is difficult to be decompressed. Therefore, it is challenging to use a partial update method while employing a compressive transmission method. According to the present inventive concept, a system that implements a partial update of an image is proposed to reduce power consumption of the display device while compressively transmitting image data.

According to the present inventive concept, a display image can be partially updated without adding a separate hardware in a compressive transmission method of image data, the partial updating method of the display image can be adopted, irrespective of compression algorithm. In addition, according to the present inventive concept, it is possible to minimize an increase in the bandwidth of a system memory.

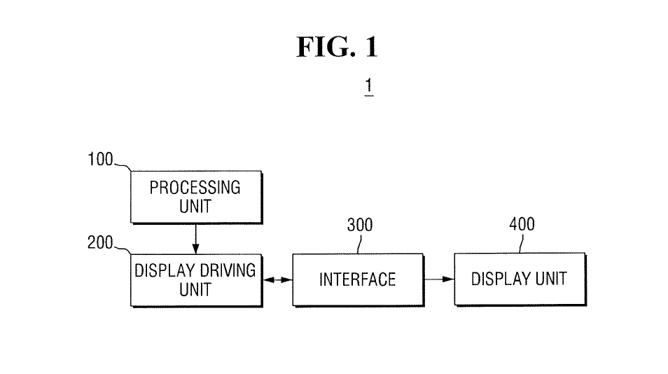

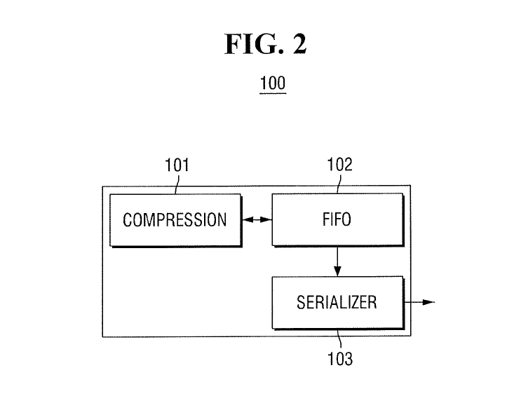

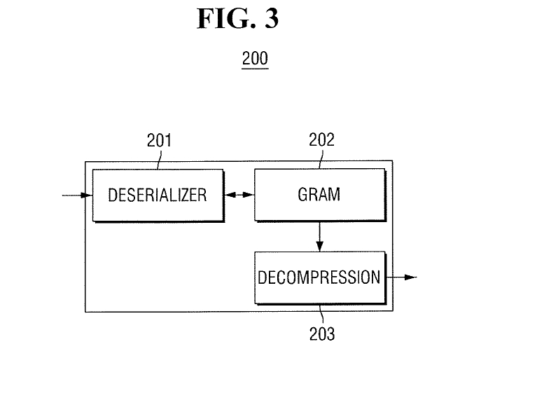

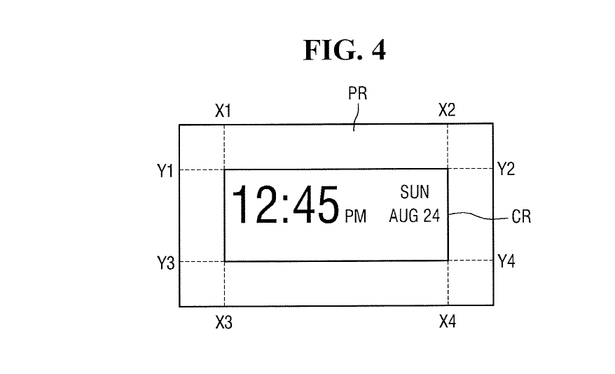

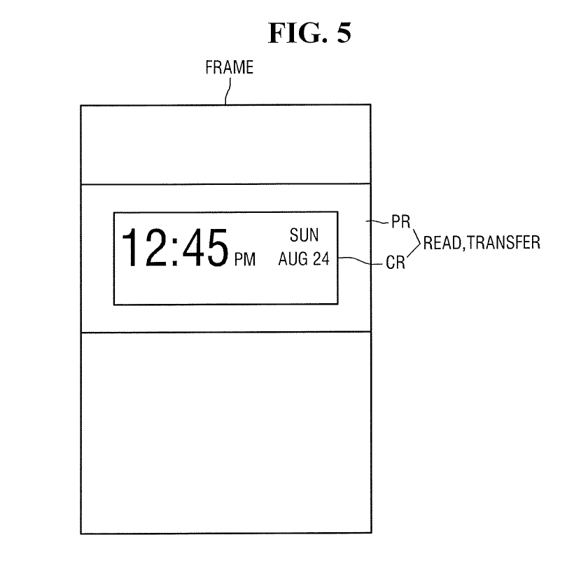

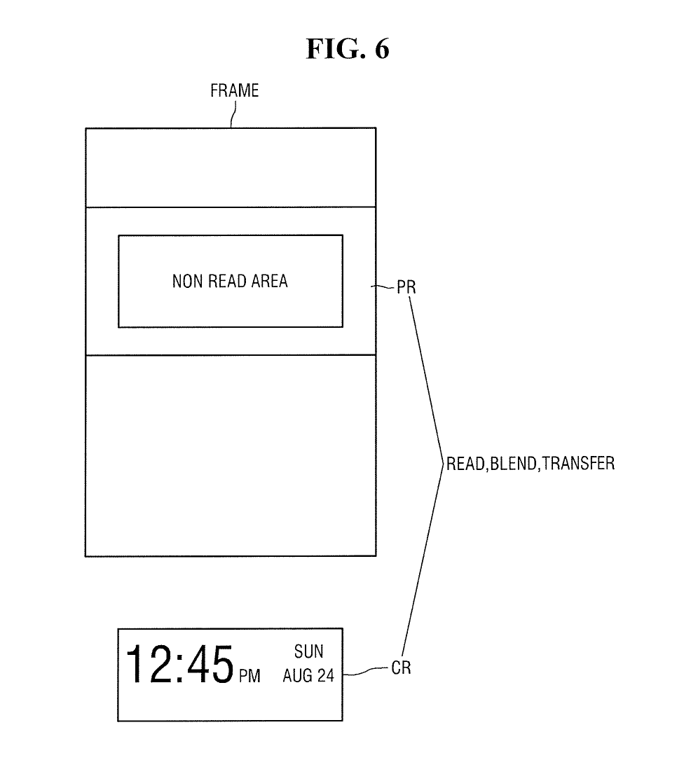

FIG. 1 is a schematic block diagram that illustrates a display device according to a first embodiment of the present inventive concept, FIG. 2 is a block diagram that illustrates specific modules of a processing unit, FIG. 3 is a block diagram that illustrates specific modules of a display driving unit, FIG. 4 schematically illustrates an updated region and a peripheral region, and FIGS. 5 and 6 illustrate a method of compressing both of image data corresponding to an updated region and image data corresponding to a peripheral region.

Referring to FIGS. 1 to 3, the display device 1 according to the first embodiment of the present inventive concept includes a processing unit 100, a display driving unit 200, an interface 300, and a display unit 400.

The processing unit 100 may control the overall operation of the display device 1. In particular, the processing unit 100 may compress image data DI corresponding to an updated region CR of the display unit 400 and a peripheral region PR adjacent to the updated region CR together and generates compressed image data DI_C.

The processing unit 100 may include a compression module 101, a first-in first-out (FIFO) memory 102, and a serializer 103 (see FIG. 2). Image data DI corresponding to the updated region CR and the peripheral region PR of the display unit 400 may be compressed together by the compression module 101. The compressed image data DI_C, which are stored in the FIFO memory 102, is serialized by the serializer 103 to output an output signal. As described above, the image data DI is compressed by the compression module 101 to then be transmitted. To overcome limitations of transmission bandwidth in a high-resolution display, such as an ultra high density (UHD), the image data DI is compressed and then transmitted.

The display driving unit 200 receives the compressed image data DI_C and decompresses the original image data DI. The display driving unit 200 may include a deserializer 201, a graphic memory (GRAM) 202, and a decompression module 203 (see FIG. 3). The serialized input signal is received and de-serialized by the deserializer 201. The compressed image data DI_C is stored in the graphic memory 202 according to the de-serialized signal and then decompressed into the original image data DI by the decompression module 203.

The decompressed original image data DI is displayed on the display unit 400 through the interface 300. The display driving unit 200 and the display unit 400 may interface with each other by a display Serial Interface (DSI) based on a mobile industry processor interface (MIPI). According to the present inventive concept, the display unit 400 may update only the image corresponding to the updated region CR using the decompressed original image data DI to display the same. This is a partial update method, and to minimize power consumption at a terminal, only the image of the updated region CR in the overall display region of the display unit 400 is updated to then be displayed.

A method for implementing a partial update process in a display device according to the present inventive concept will be described with reference to FIGS. 4 to 6.

In view of characteristics of data compression, data is compressed by referring to pixel values of a pixel in a region to be compressed and an adjacent pixel of the pixel. To partially update data, if only data of a partial region is compressed, it is challenging to decompress the compressed data of the partial region in view of a random access characteristic of the graphic memory 202. Therefore, if data transmission with compression is employed, a partial updating method cannot be used, resulting in loss in the power consumed by the display device. To address this situation, a display device according to the present inventive concept uses the following process.

According to the compression algorithm, the pixel of a region to be compressed and the adjacent pixel referred to for decompressing the compressed data may exist in units of macro blocks. In the present inventive concept, sizes of pixels X1 to X4 and Y1 to Y4 may be determined according to the size of an updated region CR to be updated (see FIG. 4), a peripheral region PR is further read, image data corresponding to the updated region CR and image data corresponding to the peripheral region PR are both compressed together to then be transmitted, and addresses are calculated based on the compressed image data DI_C to then be over-written in the graphic memory 202. For example, according to the present inventive concept, X1 to X4 may have a 2-pixel size and Y1 to Y4 may also have a 2-pixel size, but aspects of the present inventive concept are not limited thereto. According to the compression algorithm, the sizes of X1 to X4 and Y1 to Y4 may vary.

To implement the partial update process, data may be read by the processing unit 100 in different units. For example, referring to FIG. 5, the processing unit 100 may read both the image data corresponding to the updated region CR and the image data corresponding to the peripheral region PR together and may compress the read image data to transmit the same. Referring to FIG. 6, the processing unit 100 may read the image data corresponding to the updated region CR and the image data corresponding to the peripheral region PR separately, may blend the read image data and may compress and transmit the data, which will be described in more detail later.

Hereinafter, a display device according to a second embodiment of the present inventive concept will be described.

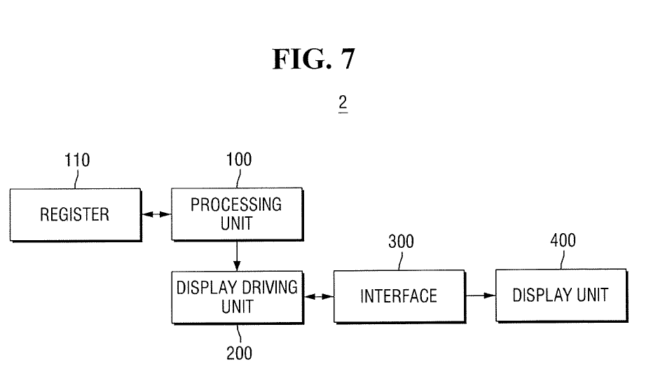

FIG. 7 is a schematic block diagram of a display device according to a second embodiment of the present inventive concept. For the sake of convenient explanation, descriptions of substantially the same components as those of the display device according to the first embodiment of the present inventive concept will be omitted.

Referring to FIG. 7, the display device 2 according to the second embodiment of the present inventive concept further includes a register 110.

The register 110 stores coordinate information of a pixel corresponding to an updated region CR. In addition, the register 110 may further store information regarding a preset size corresponding to a peripheral region PR. In a display unit 400 of the display device 2, to periodically update the image in a case where an updated image region is constant, the coordinate information of the pixels corresponding to the updated region CR is stored in the register 110. For example, if time information is displayed on the display unit 400 of a terminal, the image of the display unit 400 should be updated in units of hours, minutes and seconds. As described above, if it is necessary to repeat periodic image updates, the processing unit 100 updates the image by referring to the coordinate information stored therein, thereby improving the operating speed of the display device 2 while reducing power consumption.

In addition, to implement a partial update process, if the preset size information of the pixels corresponding to the peripheral region PR is stored in the register 110, the operating speed of the display device 2 can be improved in reading the updated region CR and the peripheral region PR. According to the compression algorithm employed to a terminal, the size of the pixel corresponding to the peripheral region PR may vary. Accordingly, to optimally implement data transmission with compression and partial data update, preset size information of the pixel corresponding to the peripheral region PR may be stored in the register 110.

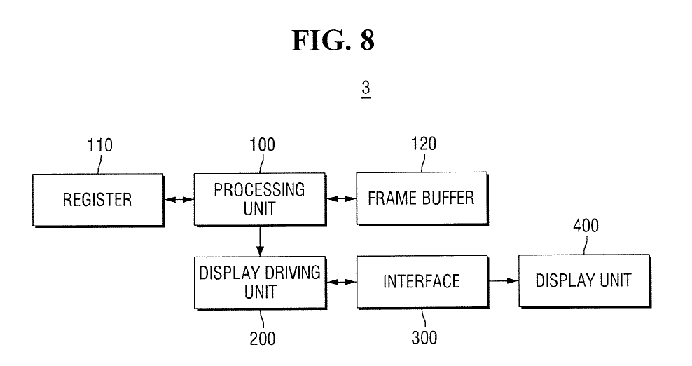

FIG. 8 is a schematic block diagram of a display device according to a third embodiment of the present inventive concept. For the sake of convenient explanation, descriptions of substantially the same components as those of the display devices according to the first and second embodiments of the present inventive concept will be omitted.

Referring to FIG. 8, the display device 3 according to the third embodiment of the present inventive concept further includes a frame buffer 120.

The frame buffer 120 stores image data to be displayed on the display unit 400. In addition, the frame buffer 120 may store image data corresponding to a peripheral region PR.

In a case where the image data corresponding to the peripheral region PR stored in the frame buffer 120 is image data of a particular color, the processing unit 100 may read only the image data corresponding to an updated region CR and may generate compressed image data DI_C. That is to say, if a particular color is displayed in a peripheral region other than an updated image region in the display unit 400 of a terminal, such as a region in which time information is displayed, the display information may be stored in the frame buffer 120. When the display information for the peripheral region other than the updated image region stored in the frame buffer 120 is the particular color image data, both the image data corresponding to the updated region CR and the image data corresponding to the peripheral region PR may be compressed together by filling a space for the image data corresponding to the peripheral region PR with the particular color image during image data compression without the need to read the information from a system memory. Accordingly, the loss of system bandwidth may become zero.

In a case where the image data corresponding to the peripheral region PR stored in the frame buffer 120 is pattern data or graphic user interface (GUI) data, the processing unit 100 may read both the image data corresponding to the updated region CR and the image data corresponding to the peripheral region PR together and may generate compressed image data DI_C. That is to say, if a pattern or a GUI image is displayed in a peripheral region other than an updated image region in the display unit 400 of a terminal, such as a region in which time information is displayed, the display information may be stored in the frame buffer 120. When display information for the peripheral region other than the updated image region stored in the frame buffer 120 is the pattern data or GUI data, the compressed image data DI_C may be generated by the method shown in FIGS. 5 and 6.

Referring to FIG. 5, in which a composition frame pre-exists so that the processing unit 100 may read only one frame, image data of a region including the updated region CR and the peripheral region PR may be read and compressed, and the compressed image data DI_C may be transmitted to the display driving unit 200.

Referring to FIG. 6, a method for reducing power consumption using a direct frame buffer scheme (DFBS) is illustrated. In this case, an updated region CR and a peripheral region PR are stored in different memory regions, image data corresponding to the updated region CR and the image data corresponding to the peripheral region PR are read by the processing unit 100 through different channels and blended, and compressed image data DI_C is then generated. The processing unit 100 transmits the compressed image data DI_C to a display driving unit 200. Here, to minimize system bandwidth loss, as shown in FIG. 6, data for a non-read area is not read and the non-read area should be filled with garbage data. Accordingly, an element used in filling the garbage data may further be required.

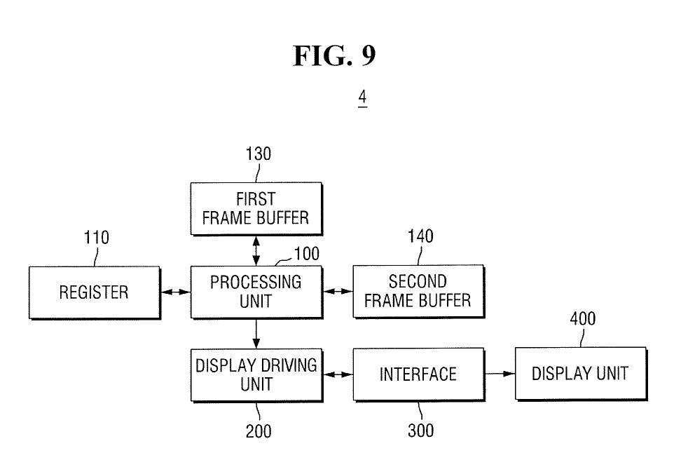

FIG. 9 is a schematic block diagram of a display device according to a fourth embodiment of the present inventive concept. For the sake of convenient explanation, descriptions of substantially the same components as those of the display device according to the third embodiment of the present inventive concept will be omitted.

Referring to FIG. 9, the display device 4 according to the fourth embodiment of the present inventive concept may further include a first frame buffer 130 and a second frame buffer 140.

The first frame buffer 130 stores first image data DI1 corresponding to an updated region CR and the second frame buffer 140 stores second image data DI2 corresponding to a peripheral region PR.

Here, a processing unit 100 may read only the first image data DI1 from the first frame buffer 130 and only the second image data DI2 from the second frame buffer 140, which will now be described with reference to FIG. 6. The first image data DI1 corresponding to the updated region CR may be read from the first frame buffer 130 and the second image data DI2 corresponding to the peripheral region PR may be read from the second frame buffer 140. Then, the first image data DI1 and the second image data DI2 may be blended and compressed to generate compressed image data DI_C.

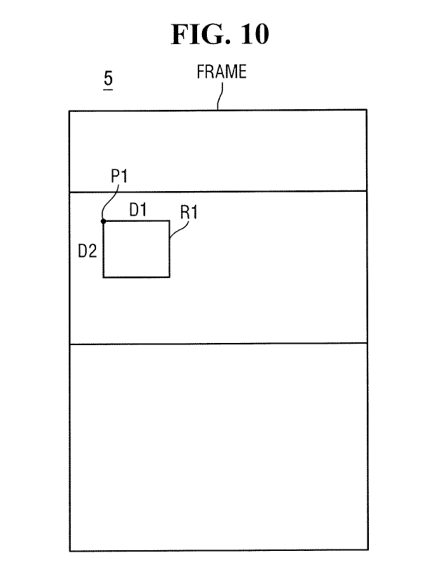

FIG. 10 is a diagram that illustrates a display device according to a fifth embodiment of the present inventive concept. For the sake of convenient explanation, descriptions of substantially the same components as those of the display device according to the second embodiment of the present inventive concept will be omitted.

Referring to FIGS. 7 and 10, the display device 5 according to the fifth embodiment of the present inventive concept includes a processing unit 100, a register 110, a display driving unit 200, an interface 300, and a display unit 400.

The processing unit 100 may control the overall operation of the display device 5. In particular, the processing unit 100 compresses first image data DI_1 of a first updated region R1 defined to be spaced apart from a first position P1 included in a frame of the display unit 400 in a horizontal direction D1 and a vertical direction D2 by a particular pixel size and generates first compressed image data DI_1_C.

The processing unit 100 may include a compression module 101, a first-in first-out (FIFO) memory 102, and a serializer 103 (see FIG. 2). The compression module 101 may compress the first image data DI_1 of the first updated region R1 included in the frame of the display unit 400. The first compressed image data DI_1_C, which is stored in the FIFO memory 102, is serialized by the serializer 103, and an output signal is output. As described above, the first image data DI_1 is compressed using the compression module 101 for transmission. To overcome limitations of transmission bandwidth in a high-resolution display, such as an ultra high density (UHD), a data compression and transmission technique is employed.

When the first image data DI_1 of the first updated region R1 is transmitted from the processing unit 100 to the display driving unit 200, a standard transmission protocol, such as a mobile industry processor interface (MIPI) may be used. However, the present inventive concept does not limit the interface between the processing unit 100 and the display driving unit 200 to that stated above. For example, other types of interfaces, including a low voltage differential signaling (LVDS) interface, a digital visual interface (DVI), a high-definition multimedia interface (HDMI), a display port (DP), a scalable versatile data link (SVDL), and so on, may be used as the interface between the processing unit 100 and the display driving unit 200.

The display driving unit 200 receives the first compressed image data DI_1_C and decompresses original first image data DI_1. The display driving unit 200 may include a deserializer 201, a graphic memory 202, and a decompression module 203 (see FIG. 3). That is to say, the display driving unit 200 receives a serialized input signal and the deserializer 201 de-serializes the input signal. The first compressed image data DI_1_C is stored in the graphic memory 202 according to the de-serialized signal and is decompressed into the first image data DI_1 by the decompression module 203.

The decompressed first image data DI_1 is displayed on the display unit 400 through the interface 300. The display driving unit 200 and the display unit 400 may interface with each other by reduce swing differential signaling (RSDS), mini-LVDS, point-to-point differential signaling (PPDS), advanced intra panel interface (AiPi), or enhanced reduced voltage signaling (eRVDS). However, the present inventive concept does not limit the interfacing method of the interface 300 to those listed above. According to the present inventive concept, the display unit 400 may update only an image corresponding to the first updated region R1 using the decompressed first image data DI_1 and may display the updated image, which is referred to as a partial update process. To minimize power consumption in a terminal, only the updated image of the first updated region R1 in the overall display region of the display unit 400 is updated and displayed.

The register 110 stores coordinate value information corresponding to the first position P1. If an image update needs to be periodically repeated for the first updated region R in the frame of the display unit 400, the processing unit 100, which stores the coordinate value information corresponding to the first position P1, updates the image by referring to the coordinate value information, thereby improving the operating speed of the display device 5 while reducing power consumption.

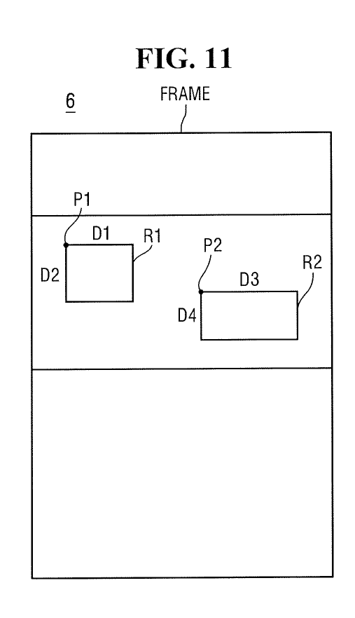

FIG. 11 is a diagram that illustrates a display device according to a sixth embodiment of the present inventive concept. For the sake of convenient explanation, descriptions of substantially the same components as those of the display device according to the fifth embodiment of the present inventive concept will be omitted.

Referring to FIGS. 7 and 11, the display device 6 according to the sixth embodiment of the present inventive concept includes a processing unit 100, a register 110, a display driving unit 200, an interface 300, and a display unit 400.

The processing unit 100 may control the overall operation of the display device 6. In particular, the processing unit 100 compresses first image data DI_1 of a first updated region R1 defined to be spaced apart from a first position P1 included in a frame of the display unit 400 in a horizontal direction D1 and a vertical direction D2 by a particular pixel size, compresses second image data DI_2 of a second updated region R2 defined to be spaced apart from a second position P2 in a horizontal direction D3 and a vertical direction D4 by the particular pixel size, and generates first compressed image data DI_1_C and second compressed image data DI_2_C.

The processing unit 100 may include a compression module 101, a FIFO memory 102, and a serializer 103 (see FIG. 2). The compression module 101 may compress the first image data DI_1 of the first updated region R1 and the second image data DI_2 of the second updated region R2 included in the frame of the display unit 400. The first compressed image data DI_1_C and the second compressed image data DI_2_C, which are stored in the FIFO memory 102, are serialized by the serializer 103, and output signals are output. As described above, the first image data DI_1 and the second image data DI_2 are compressed using the compression module 101 for transmission. To overcome limitations of transmission bandwidth in a high-resolution display, such as an ultra high density (UHD), a data compression and transmission technique is employed.

The display driving unit 200 receives the first compressed image data DI_1_C and the second compressed image data DI_2_C and decompresses original first image data DI_1 and second image data DI_2. The display driving unit 200 may include a deserializer 201, a graphic memory 202, and a decompression module 203 (see FIG. 3). That is to say, the display driving unit 200 receives a serialized input signal and the deserializer 201 de-serializes the input signal. The first compressed image data DI_1_C and the second compressed image data DI_2_C are stored in the graphic memory 202 according to the de-serialized signal and are decompressed into the first image data DI_1 and the second image data DI_2 by the decompression module 203, respectively.

The decompressed first image data DI_1 and the decompressed second image data DI_2 are displayed on the display unit 400 through the interface 300. The display driving unit 200 and the display unit 400 may interface with each other by display serial interface (DSI) based on mobile industry processor interface (MIPI). According to the present inventive concept, the display unit 400 may update an image corresponding to the first updated region R1 or an image corresponding to the second updated region R2 using the decompressed first image data DI_1 or the decompressed second image data DI_2 and may display the updated images, which is referred to as a partial update process. To minimize power consumption in a terminal, the updated image of the first updated region R1 and the updated image of the second updated region R2 in the overall display region of the display unit 400 are updated and displayed.

The register 110 stores first coordinate value information corresponding to the first position P1 or second coordinate value information corresponding to the second position P2. If an image update needs to be periodically repeated for the first updated region R1 and the second updated region R2 in the frame of the display unit 400, the processing unit 100, which stores the first or second coordinate value information corresponding to the first position P1 or the second position P2, updates the image by referring to the coordinate value information, thereby improving the operating speed of the display device 6 while reducing power consumption.

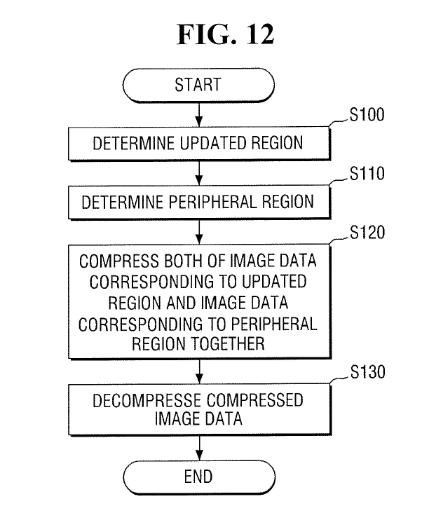

Hereinafter, an image update method of a display device according to an embodiment of the present inventive concept will be described with reference to FIG. 12.

FIG. 12 is a flowchart that sequentially illustrates an image update method of a display device according to an embodiment of the present inventive concept.

Referring to FIG. 12, first, an updated region CR of a display unit 400 is determined (S100). In the display unit 400, the updated region CR may be preset.

For the updated region CR, an adjacent peripheral region PR is determined (S110). The peripheral region PR is adjacent to the updated region CR and is determined by preset size information. As described above, the size of the peripheral region PR may vary according to the compression algorithm, and the preset size information for the peripheral region PR may also vary and be stored.

Next, both image data corresponding to the updated region CR and image data corresponding to the peripheral region PR are compressed together (S120). Here, the image data may be compressed by the following techniques.

First, both the image data corresponding to the updated region CR and the image data corresponding to the peripheral region PR are read together and compressed. In this case, since a composition frame for the updated region CR and the peripheral region PR pre-exists, the processing unit 100 may only read one frame.

Second, the image data corresponding to the updated region CR and the image data corresponding to the peripheral region PR may be read through different channels and blended, followed by compressing the image data. This technique is used to reduce power consumption using a direct frame buffer scheme (DFBS).

Third, in a case where the image data corresponding to the peripheral region PR is particular color image data, only the image data corresponding to the updated region CR may be read and then compressed. When the particular color image data is stored in the frame buffer 120, the image data may be compressed by filling a space for the image data corresponding to the peripheral region PR with the particular color image during image data compression without the need to read the information from a system memory. In this case, the system bandwidth loss may become zero.

Next, the display driving unit 200 may decompress the compressed image data DI_to be displayed on the display unit 400 and may generate original image data DI to then generate an updated image (S130). The updated image is displayed on the display unit 400, thereby implementing an image partial update.

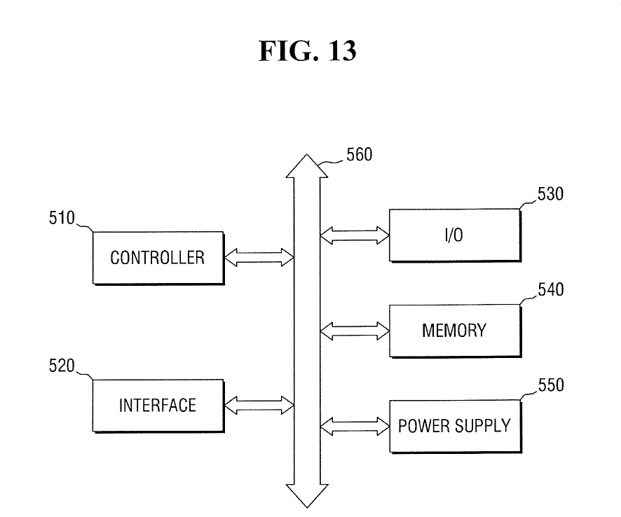

Hereinafter, an electronic system including display devices according to various embodiments of the present inventive concept will be described. FIG. 13 is a schematic block diagram of an electronic system including display devices according to various embodiments of the present inventive concept.

Referring to FIG. 13, the electronic system may include a controller 510, an interface 520, an input/output device (I/O) 530, a memory 540, a power supply 550, and a bus 560.

The controller 510, the interface 520, the I/O 530, the memory 540, and the power supply 550 may be connected to each other through the bus 560. The bus 560 may correspond to a path through which data moves.

The controller 510 may include at least one of a microprocessor, a microcontroller, and logic elements capable of functions similar to those elements.

The interface 520 may transmit data to a communication network or receive data from the communication network. The interface 520 may be wired or wireless. For example, the interface 520 may include an antenna or a wired/wireless transceiver, and so on.

The I/O 530 may include a keypad, a display device, and so on, and may input/output data. The display devices according to some embodiments of the present inventive concept may be provided with components of the I/O 530.

The memory device 540 may store data and/or codes.

The power supply 550 may convert externally input power to then provide the converted power to various components 510 to 540.

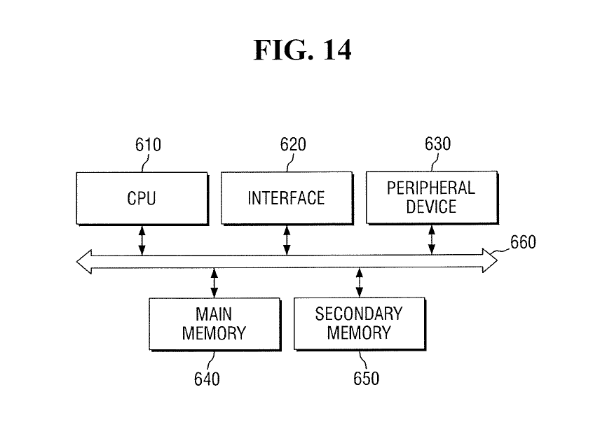

FIG. 14 is a schematic block diagram of an application example of an electronic system including display devices according to various embodiments of the present inventive concept.

Referring to FIG. 14, the electronic system may include a central processing unit (CPU) 610, an interface 620, a peripheral device 630, a main memory 640, a secondary memory 650, and a bus 660.

The CPU 610, the interface 620, the peripheral device 630, the main memory 640, and the secondary memory 650 may be connected to each other through the bus 660. The bus 660 may correspond to a path through which data moves.

The CPU 610, including a controller, an operation device, etc., may execute a program and process data.

The interface 620 may transmit data to a communication network or may receive data from the communication network. The interface 620 may be configured in a wired/wireless manner. For example, the interface 620 may be an antenna or a wired/wireless transceiver.

The peripheral device 630, including a mouse, a keyboard, a display device, a printer, etc., may input/output data. Display devices according to some embodiments of the present inventive concept may be provided with components of the peripheral device 630.

The main memory 640 may transceive data to/from the CPU 610 and may store data and/or commands required to execute the program.

The secondary memory 650, including a nonvolatile memory, such as a floppy disk, a hard disk, a CD-ROM, or a DVD, may store the data and/or commands. The secondary memory 650 may store data even in an event of power interruption of the electronic system.

In addition, display devices according to some embodiments of the present inventive concept may be provided as one of various components of an electronic device, including a computer, an ultra mobile personal computer (UMPC), a work station, a net-book, a personal digital assistant (PDA), a portable computer, a web tablet, a wireless phone, a mobile phone, a smart phone, an e-book, a portable multimedia player (PMP), a potable game console, a navigation device, a black box, a digital camera, a 3-dimensional (3D) television, a digital audio recorder, a digital audio player, a digital picture recorder, a digital picture player, digital video recorder, a digital video player, a device capable of transmitting/receiving information in wireless environments, one of various electronic devices constituting a home network, one of various electronic devices constituting a computer network, one of various electronic devices constituting a telematics network, RFID devices, or embedded computing systems.

While embodiments of the present inventive concept have been particularly shown and described with reference to exemplary embodiments thereof, it will be understood by those of ordinary skill in the art that various changes in form and details may be made therein without departing from the spirit and scope of the present inventive concept as defined by the following claims. It is therefore desired that the present embodiments be considered in all respects as illustrative and not restrictive, reference being made to the appended claims rather than the foregoing description to indicate the scope of the inventive concept.

What is claimed is:

1. A display device comprising:
a display unit;
a processing unit configured to compress both image data corresponding to an updated region of the display unit and image data corresponding to a peripheral region adjacent to the updated region together and generating compressed image data; and
a display driving unit configured to receive the compressed image data and decompressing the image data,
wherein the display unit is configured to display an image corresponding to the updated region by the decompressed image data.

2. The display device of claim 1, further comprising a register configured to store coordinate information of a pixel corresponding to the updated region.

3. The display device of claim 2, wherein the register further stores predefined size information corresponding to the peripheral region.

4. The display device of claim 1, further comprising a frame buffer configured to store image data to be displayed on the display unit.

5. The display device of claim 4, wherein the frame buffer stores image data corresponding to the peripheral region.

6. The display device of claim 5, wherein when the image data corresponding to the peripheral region stored in the frame buffer is image data of a particular color, the processing unit reads only image data corresponding to the updated region and generates the compressed image data.

7. The display device of claim 5, wherein when the image data corresponding to the peripheral region stored in the frame buffer is pattern data or graphic user interface (GUI) data, the processing unit reads both image data corresponding to the updated region and image data corresponding to the peripheral region and generates the compressed image data.

8. The display device of claim 4, wherein the frame buffer includes a first frame buffer for storing first image data corresponding to the updated region and a second frame buffer for storing second image data corresponding to the peripheral region.

9. The display device of claim 8, wherein the processing unit reads only the first image data from the first frame buffer and reads only the second image data from the second frame buffer.

10. The display device of claim 9, wherein the processing unit blends the first image data and the second image data and compresses the blended image data to generate the compressed image data.

11. A display device comprising:
a display unit;
a processing unit configured to compress first image data of a first updated region defined to be horizontally and vertically spaced apart from a first position in a frame of the display unit by a particular pixel size and generating first compressed image data; and
a display driving unit configured to receive the first compressed image data and decompressing the first image data,
wherein the display unit is configured to display an image corresponding to the first updated region by the decompressed first image data.

12. The display device of claim 11, further comprising a first register configured to store coordinate value information corresponding to the first position.

13. The display device of claim 11, wherein the processing unit further generates second compressed image data by compressing second image data of a second updated region defined to be horizontally and vertically spaced apart from a second position different from the first position in the frame of the display unit by a particular pixel size, the display driving unit receives the second compressed image data and decompresses the second image data, and the display unit displays images corresponding to the first and second updated regions by the decompressed first and second image data.

14. The display device of claim 13, further comprising a second register configured to store coordinate value information corresponding to the first position or the second position.

15. The display device of claim 11, further comprising a frame buffer configured to store image data to be displayed on the display unit.

16. A method for image update of a display device comprising:
determining an updated region of a display unit;
determining a peripheral region adjacent the updated region by preset size information;
compressing both image data corresponding to the updated region and the peripheral region together; and
decompressing the compressed image data to generate an updated image to be displayed on the display unit.

17. The method of claim 16, wherein compressing both the image data corresponding to the updated region and the peripheral region together comprises reading and compressing both the image data corresponding to the updated region and the peripheral region together.

18. The method of claim 16, wherein compressing both the image data corresponding to the updated region and the peripheral region together comprises reading through different channels and blending the image data corresponding to the updated region and the peripheral region, and compressing both of the image data together.

19. The method of claim 16, where the image data corresponding to the peripheral region is predetermined color image data, wherein compressing both the image data corresponding to the updated region and the peripheral region together comprises reading the image data corresponding to the updated region only and compressing both of the image data together.

20. The method of claim 16, wherein the preset size information for the peripheral region varies according to a compression algorithm.
